(19) United States
(12) Patent Application Publication
(10) Pub. No.: US 2015/0082696 A1
(43) Pub. Date: Mar. 26, 2015

(54) HORTICULTURAL GROW GUTTER

(71) Applicant: Formflex Automation USA, LTD., Wayland, MI (US)

(72) Inventors: Arie Pieter Nicolaas Barendregt, Grimsby (CA); Johan ten Veen, Kwintshuel (NL); Arjan Kouwenhoven, Monster (NL)

(73) Assignee: FORMFLEX AUTOMATION USA, LTD., Wayland, MI (US)

(21) Appl. No.: 14/037,551

(22) Filed: Sep. 26, 2013

(51) Int. Cl. A01G 27/00

(52) U.S. Cl. CPC A01G 27/00
USPC 47/66.7; 47/80; 29/891

(57) ABSTRACT

A horticultural system having a horticultural grow gutter produced from a single sheet of material and including an upper bridge a length, a bottom surface, and two side edges. Two upwardly facing upper channel sections are each individually integral with one of the two side edges along the length of the upper bridge section. The upwardly facing channel sections have a channel bottom having a plurality of apertures configured to allow a liquid to pass through the apertures by gravity. Two side panels are each individually integral with one of the top edges and extend downward from the top edge. An inwardly bent and upwardly facing lower channel section is integral with each side panel and the upwardly facing lower channel section is sized and positioned to receive the liquid passing through the apertures disposed below the upper channel section.

### BACKGROUND OF THE INVENTION

The present invention generally relates to a horticultural grow gutter, also referred to as a growing gutter, providing a draining system which allows cultivation of a garden, orchard, or nursery having flowers, fruits, vegetables, or other ornamental plants, and a method for constructing such grow gutters.

### SUMMARY OF THE INVENTION

One aspect of the present invention includes a horticultural system having a horticultural grow gutter produced from a single sheet of material, typical steel or sheet metal, and including an upper bridge section having an upper nutrition mat receiving top surface. The horticultural grow gutter also has a length, a bottom surface, and two side edges. Two upwardly facing upper channel sections are each individually integral with one of the two side edges along at least substantially all of the length of the upper bridge section. The upwardly facing channel sections have a top edge extending above the upper nutrition mat receiving top surface and a channel bottom having a plurality of apertures positioned in the bottom of the upwardly facing upper channel section and configured to allow a liquid to pass through the apertures by gravity. Two side panels are each individually integral with one of the top edges and extend downward from the top edge. An inwardly bent and upwardly facing lower channel section is integral with each side panel and the upwardly facing lower channel section is sized and positioned to receive the liquid passing through the apertures disposed below the upper channel section.

One aspect of the present invention includes a horticultural grow gutter which includes an upper bridge section having an upper nutrition mat receiving member, a bottom surface, and at least two side edges. Moreover, the horticultural grow gutter includes an upwardly facing upper channel section which is integral with at least one of the at least two side edges. The upwardly facing upper channel section also includes a top edge. At least one side panel extends downward from the top edge of the upwardly facing upper channel section which is integral with at least one of the at least two side edges. The upwardly facing upper channel section also includes a top edge. At least one side panel extends downward from the top edge of the upwardly facing upper channel section and forms an inwardly bent, and upwardly facing lower channel section which is disposed below the upper channel section. The lower channel section is configured to receive water or other liquid from the upper channel section.

Another aspect of the present invention includes a horticultural grow gutter which includes an upper bridge section having an upper nutrition mat receiving member, a downwardly concave bottom surface, and at least two side edges which extend an entire length of the upper bridge section. Moreover, at least one generally U-shaped, upwardly facing, upper channel section is integral with at least one of the at least two side edges. The upwardly facing upper channel section includes a top edge which extends the entire length of the upper bridge section. Additionally, at least one downwardly extending side panel extends from the top edge and forms an inwardly bent, and upwardly facing, lower channel section. The lower channel section is configured to receive water or other liquid from the upper channel section. Moreover, the bottom surface of the upper bridge section is permanently visible throughout the entire length of the bridge section.

Yet another aspect of the present invention includes a method of producing a grow gutter including the following steps. First, providing a single, non-pre-punched sheet of material (a sheet of material that is free of any punched sections forming one or more perforated apertures in the sheet of material) into a upper bridge section having an upper nutrition mat receiving member, a bottom surface, and at least two side edges. The machine also forms an upwardly facing upper channel section which is adjacent to at least one of the at least two side edges and includes a top edge. Moreover, the machine forms at least one side panel which extends downward from the top edge and forms an inwardly bent and upwardly facing lower channel section. Next, the water or other liquid is drained from the upper nutrition mat receiving member into the upper channel section. Finally, the water or other liquid is received into the lower channel section through a plurality of pass through apertures which are disposed on the upper channel section.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partial top perspective view of the horticultural grow gutter apparatus according to an aspect of the present invention;

FIG. 2A is a partial bottom right perspective view of the horticultural grow gutter apparatus according to an aspect of the present invention;

FIG. 2B is a partial bottom left perspective view of the horticultural grow gutter apparatus according to an aspect of the present invention;

FIG. 3A is a partial top plan view of the horticultural grow gutter apparatus according to an aspect of the present invention;

FIG. 3B is a partial bottom plan view of the horticultural grow gutter apparatus according to an aspect of the present invention;

FIG. 4 is a top plan view of the horticultural grow gutter apparatus according to an aspect of the present invention;

FIG. 5 is a cross-sectional view of the horticultural grow gutter apparatus according to an aspect of the present invention;

FIG. 5A is an enlarged partial cross-sectional view of the horticultural grow gutter apparatus according to an aspect of the present invention;

FIG. 6 is a top perspective view of the horticultural grow gutter apparatus installed according to an aspect of the present invention; and

FIG. 7 is a front perspective view of a machine used to form the horticultural grow gutter apparatus according to an aspect of the present invention.

### DETAILED DESCRIPTION OF PREFERRED EMBODIMENT

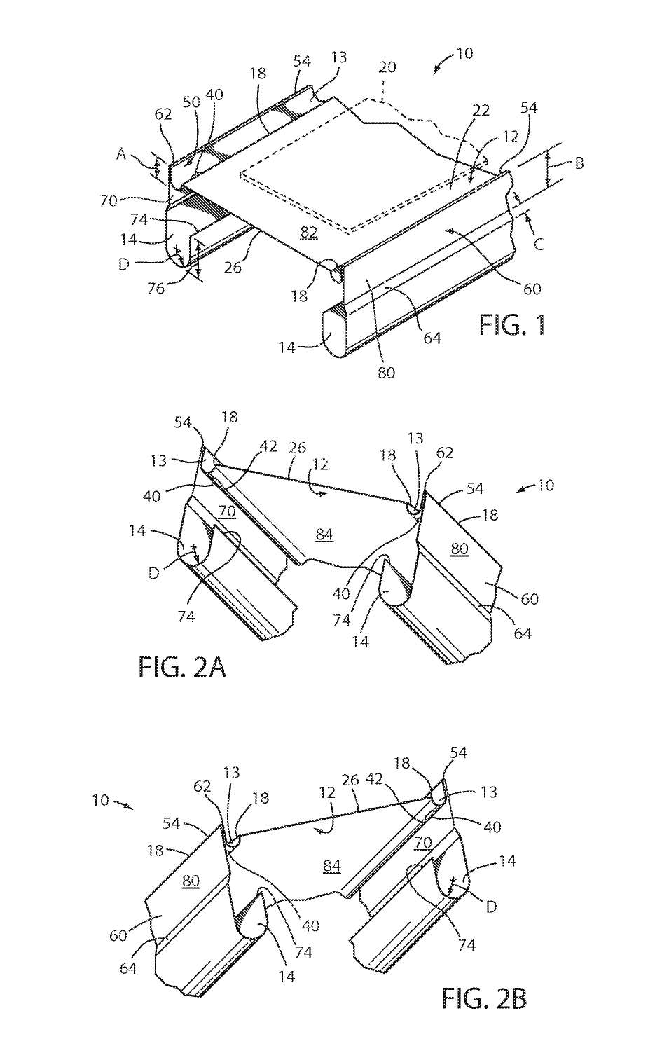

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these small ranges may independently be included in the smaller ranges, and are also encompassed within the invention, subject to any specifically excluded limit in the stated range. Where the stated range includes one or both of the limits, ranges excluding either or both of those included limits are also included in the invention. In this specification and the appended claims, the singular forms “a,” “an” and “the” include plural reference unless the context clearly dictates otherwise.

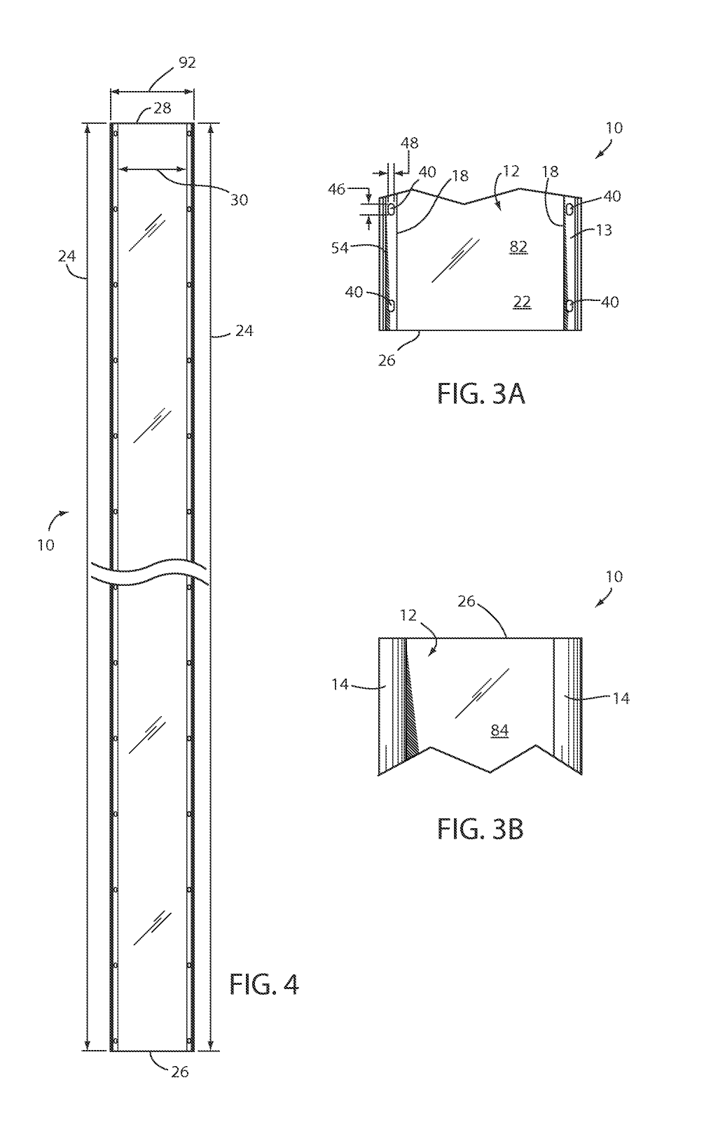

FIGS. 1-5 generally show a horticultural grow gutter 10. The horticultural grow gutter 10 of the present invention is typically formed from a single piece of metal or plastic and includes an upper bridge section 12, two upwardly facing upper channel sections 13 disposed along at least substantially all, and more typically along the entire length of the grow gutter, and upwardly facing lower channel section 14 positioned beneath the upwardly facing upper channel sections and running at least substantially the length of the grow gutter or the entire length of the grow gutter.

The upper bridge section 12 of the horticultural grow gutter 10 includes a top surface 82 and a bottom surface 84, and at least two side edges 18. A nutrition mat 20 is typically place don the top surface of the bridge section 12. The side edges 18 are disposed on either side of the upper bridge section 12 and extend an entire length 24 or at least substantially all of the entire length of the horticultural grow gutter. The side edges 18 form a generally rectangular surface with a front edge 26 and a rear edge 28. The upper bridge section 12 between the edges 18 and the front edge 26 and rear edge 28 may be a generally flat, aperture free and recess free, rectangular surface. The upper bridge section 12 may be slightly concave down in order to allow drainage from the top surface 82 and a nutrition mat 20 down toward the at least two side edges 18 by gravity when the grow gutter 10 is mounted. The nutrition mat is typically a pre-formed plant nutrient providing material configured to germinate and/or grow one or more plants of various plant varieties. The nutrition mat may be soil, a composite of soil and fertilizer and/or a synthetic man-made growing/nutrient providing material. Typically, the nutrition mat is positioned along the entire length or substantially all of the entire length 24 of the grow gutter 10; however, a plurality of nutrition mats may be positioned along only portions, substantially all or all of the top surface of the upper bridge member. There conceivably may be space or gaps between nutrition mats or they may physically abut one another.

The upper bridge section 12 has a width 30 of from approximately 200 to approximately 250 centimeters and most typically approximately 220 centimeters. The bottom surface 84 may correspondingly be slightly concaved down or a generally flat surface. Moreover, typically, the bottom surface 84 is visible throughout the entire length of the upper bridge section 12 when viewed from a bottom perspective, as shown in FIGS. 2A-2B. There is typically no other portion of the grow gutter other than the upper bridge section 12 that interconnects the upwardly facing upper channel sections 13 and the upwardly facing lower channel sections 14.

The upwardly facing upper channel section 13 is formed integral with each of the side edges 18, forming two upwardly facing upper channel sections 13 disposed on opposing sides of the upper bridge section 12. Water or other liquid received on the top surface 82 and the nutrition mat 20 collects via gravity in the upwardly facing upper channel section 13. The upwardly facing upper channel section 13 is typically generally a U-shaped channel that typically extends along the entire length 24 of the upper bridge section 12. The upwardly facing upper channel section 13 may be completely level with the ground or may be slightly slanted along the length of the grow gutter in order to prevent standing water or other liquid by allowing gravity to move liquid within the channel along the length of the channel.

The upwardly facing upper channel section 13 further includes a plurality of pass-through apertures, or holes 40. The holes 40 are typically disposed in a bottom 42 of the upper channel section 13 and are typically linearly spaced apart throughout an entire length 24 of the upper channel section 13. The holes 40 or apertures are typically oval-shaped or capsule-shaped (rectangular center section with arch-shaped ends), but may also be circular, triangular, square, star-shaped, heart-shaped, or any other shape as known by one of ordinary skill in the art. The holes 40 typically have a length 46 of approximately 10 to 20 centimeters, most typically approximately 15 centimeters. The holes 40 also have a width 48 of approximately 5 to 10 centimeters and most typically approximately 8 centimeters. The holes 40 typically have arch-shaped ends. The holes 40 in the upwardly facing upper channel section 13 are specifically designed such that the opening of the holes 40 is minimized to prevent blockage and to allow only water or other liquid to fall through the holes 40 of the upwardly facing upper channel section 13. The holes 40 are typically mechanically punched completely through the upper channel section 13 and are typically disposed approximately 250-750 mm apart and specifically approximately 500 mm apart. The holes 40 are typically punched on-site and can be made to any desired shape or configuration as desired by individual customers.

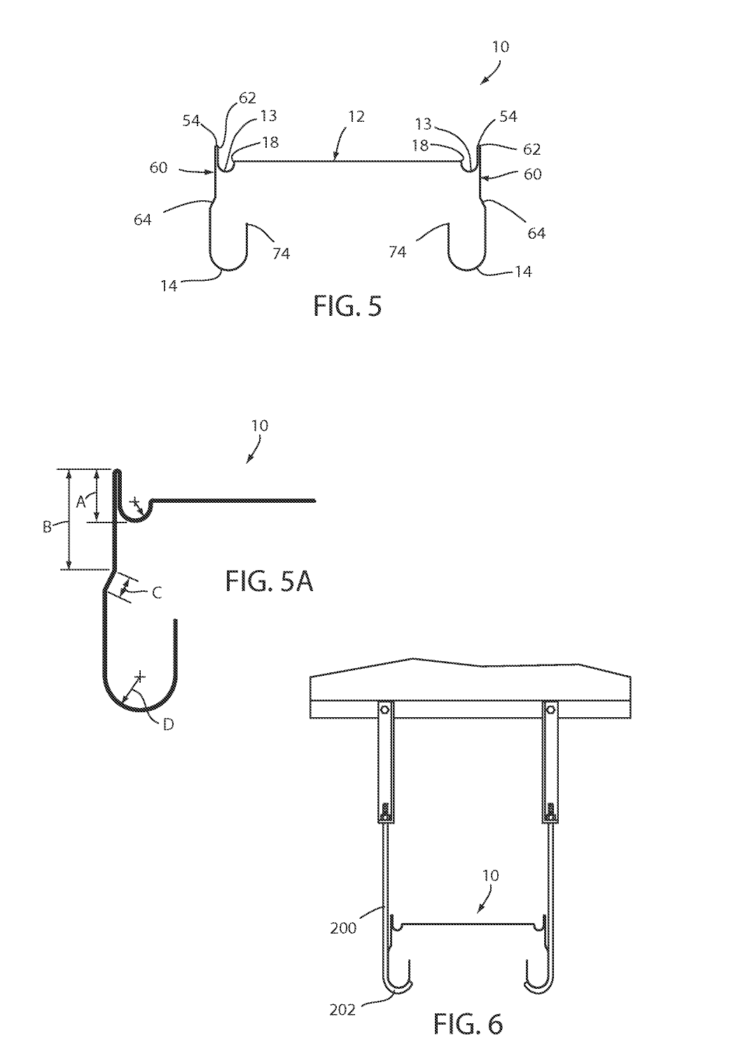

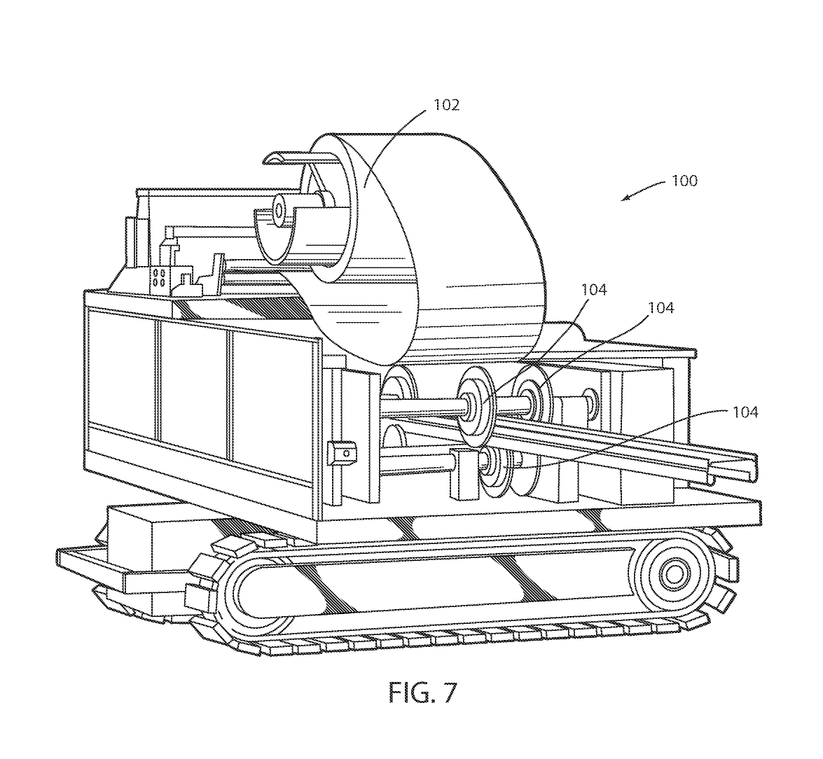

The upper channel section 13 also typically has a radius 50 of from approximately 6 to approximately 10 centimeters and most typically about or exactly 7.5 centimeters. Moreover, the upper channel section 13 from the side edges 18 of the upper bridge section 12 to the deepest portion of the upper channel section 13 is approximately 10 centimeters deep. On the opposite side of the upper channel section 13 from the side edge 18 is a top edge 54 of the upper channel section. The top edge 54 of the upper channel section 13 extends upward approximately 10 to 20 centimeters, and most typically approximately 15 centimeters above the side edge 18 (see length B in FIG. 5A).

A side panel 60 is integral with and extends downward from each of the top edges 54 of the upwardly facing upper channel sections 13. The side panel 60 extends downward from the top edge 54 from approximately 100 to 150 centimeters and most typically approximately 121 centimeters and to a point sufficiently below the upper channel section 13 to allow the upwardly facing lower section 14 to be formed under the upper channel sections 13. The top edge 54 of the upwardly facing upper channel section 13 and the side panel 60 form a small semi-circle or looped portion 62. The looped portion 62 may also be linear or flattened. However, the looped portion 62 is typically semi-circle or looped in order to provide strength to the horticultural grow gutter 10. The looped portion 62 between the upwardly facing upper channel section 13 and the side panel 60 improves the rigidity and strength of the horticultural grow gutter 10. The portion of the upper channel section 13 that extends upward to the top edge 54 and the side panel extending down from the top edge 54 typically are proximate one another or physically engage one another to provide strength.

The side panel 60 also includes an outwardly projecting section 64. The outwardly projecting section 64 has a length C (see FIG. 5A) of from approximately 8 to 12 centimeters and typically approximately 10 centimeters, and projects outward away from the upper bridge section approximately 2 to 7 centimeters and most typically approximately 5 centimeters. The outwardly projecting section 64 of the side panel 60 also allows stacking or nesting of the horticultural grow gutter 10 on top of each other during manufacturing and shipping. The outwardly projecting section 64 of the side panel 60 is configured to provide the lower channel section 14 with a larger radius 68 than the radius 50 of the upper channel section 13 such that all of the water or other liquid falling through the holes 40 in the upper channel section 13 to the lower channel section 14 is received into the lower channel section 14. The outwardly projecting section 64 may also be configured to provide a capillary effect to the water or other liquid which is dripping from the holes 40 from the upper channel section 13 into the lower channel section 14 such that when a droplet of water or other liquid falls from the holes 40 in the upper channel section 13, the water is then disposed onto an inside surface 70 of the side panel 60 and follows along the outwardly projecting section 64 into the lower channel section 14.

The side panel 60 continues to extend downward from the outwardly projecting section 64 and is upwardly and inwardly bent in order to form the upwardly facing upper channel section 13. The upwardly facing lower channel section 14 has a diameter D (see FIG. 5A) or width of from approximately 30 to about 40 centimeters, and most typically approximately 35 centimeters and is disposed directly below the upwardly facing upper channel section 13. The lower channel section 14 is a generally U-shaped channel. The lower channel section 14 further includes an inward edge 74 and has a height of from approximately 40 to approximately 50 centimeters and most typically approximately 45 centimeters from the bottom of the upwardly facing upper channel section.

The upwardly facing lower channel section 14 is inwardly facing so as to prevent contamination from root growth. In prior art plant breeding gutters, protruding plant roots emerging from the nutrition mats lay in drain water of outwardly oriented channels. When the roots lay in drain water there is a chance of undesired virus or bacterial or fungi contamination from one plant to another if the drain water becomes contaminated because plant diseases are transferred via water in which the roots are placed. The horticultural grow gutter 10 of the present invention eliminates such chances of virus or other contamination.

In operation, the horticulture will grow from the nutrition mat 20. Once long enough, the roots of the horticulture will reach the top edge 54 of the upper channel section 13 and then fall downward onto an outside surface 80 of the side panel 60. Because the upwardly facing lower channel section 14 faces inward, the roots do not come into contact with the lower channel section 14 so as to prevent decontamination of the plants. Also having the lower channel section 14 facing inward allows no dirt, algae or leaves falling from the plant to fall directly into the lower channel section 14, resulting in less contamination to the water or other liquid in the lower channel section 14. Furthermore, because the two opposing upwardly facing lower sections are not interconnected using a planar material covering the bottom surface of the upper bridge section, one can visually inspect the upwardly facing lower sections of the present grow gutters. The lower channel section 14 is only connected to the side panel 60 and is not connected to any other portion of the horticultural grow gutter 10. The open orientation of the lower channel section 14 allows a user to clean the lower channel section 14 without deconstructing the horticultural grow gutter 10. As mentioned, the inwardly facing lower channel section 14 also allows a user to see if dirt, algae or other contaminates fall into the lower channel section 14 through the holes 40 of the upper channel section 13. The open air construction of the upwardly facing lower channel section 14 allows ventilation to the lower channel section 14 which helps prevent diseases or other contamination inside of the grow gutter. This configuration also allows for no fruit contamination with drain water.

The horticultural grow gutter 10 is typically comprised of a strong sturdy material, such as steel, but could conceivably be made of plastic. The steel may be brushed steel, painted steel, or stainless steel as would be used by one of ordinary skill in the art. Moreover, the horticultural grow gutter 10 may also be comprised of any sturdy material which provides the desired strength and rigidity desired to produce the horticultural grow gutter. Most typically, the horticultural grow gutter 10 is comprised of three quarter inch galvanized steel. The material is typically painted with a food safe primer and then coated with a food safe coating. The food safe primer and the food safe coating are both typically a polyester paint which coats the horticultural grow gutter 10 in order to provide a food safe barrier between plants grown on the surface of the horticultural grow gutter 10 and the steel material. Typically both top surface 82 and bottom surface 84 of the horticultural grow gutter 10 include the food safe primer and the food safe coating; however, it is contemplated that only one surface or only a portion of one surface or portions of both surfaces may include the food safe coating and the food safe primer.

The horticultural grow gutter 10 of the present invention is typically hung from a ceiling in a greenhouse or other grow house by steel or plastic rods. Typically the horticultural grow gutter 10 is hung from approximately 0.5 meter to about 3 meters from the ceiling and most typically approximately 1 meter from the ceiling. This height gives optimal growing room for the plants and also allows the roots of the plants to hang below the grow gutter. The horticultural grow gutter 10 of the present invention typically has a length 24 of from approximately 3.5 to approximately 6 meters, and most typically approximately 5 meters. In operation, the horticultural grow gutter 10 is hung from the ceiling, as described above, and attachment mechanisms from the ceiling to the horticultural grow gutter 10 may be a great length apart, typically approximately 3 to 8 meters and most typically approximately 5 meters. In order to support the nutrition mat 20 and horticulture, the horticultural grow gutter 10 must be a rigid member and capable of supporting the weight of the nutrition mat 20 and any horticulture desired by a consumer.

An advantage of the present invention is that the horticultural grow gutter 10 can be made from a single sheet of flat (unshaped) steel. The single sheet of steel has no pre-punched holes, and can be purchased from any steel supplier in the United States and abroad. The pre-punched steel used in prior art applications typically comes from Europe and has a higher cost than non-pre-punched steel due to processing costs. Using single sheeted, non-pre-punched steel of the present invention allows the horticultural grow gutter 10 to be less expensive than traditional grow gutters using pre-punched steel.

The description above is describing a single portion of the horticultural grow gutter 10 and the complete horticultural grow gutter 10 will include a single upper bridge section 12 with one upwardly facing upper channel section 13 integral with each side edge 18 of the upper bridge section 12. The downwardly extending side panel 60 extends from each of the upwardly facing upper channel sections 13 and are bent to form the upwardly extending lower channel sections 14. The horticultural grow gutter 10 is generally symmetrical and typically has a maximum width 92 of from approximately 250 to approximately 275 centimeters and most typically approximately 266 centimeters.

The present invention also relates to methods for the production of the novel horticultural grow gutter 10 for greenhouse farming from rolls of flat material, usually steel, typically continuously and over large lengths that may be cut with a material (steel) cutter as the grow gutter is being produced. As shown in FIG. 6, typically a roll forming machine 100 for continuous production of the gutter 10 is used. The horticultural grow gutter 10 is formed from a single piece of non-pre-punched steel and typically begins in a roll of steel 102. The roll of steel 102 is unrolled by the roll forming machine 100 while the roll forming machine 100 bends the single piece of non-punched steel into the horticultural grow gutter 10 of the present invention. The roll forming machine 100 employs several sets of rollers 104 which operate to form the upper bridge section 12, the upwardly facing upper channel section 13, and the downwardly extending side panel 60, which is inwardly bent in order to form the upwardly facing lower channel section 14.

Specifically, the method begins by providing the single, non-pre-punched sheet of material which is typically steel. Next, the roll forming machine 100, which is typically portable such that the grow gutters may be made to length needed for an individual greenhouse on-site, is used to form from the single non-pre-punched sheet of material the upper bridge section 12, and the at least two side edges 18. The roll forming machine 100 forms the upwardly facing upper channel section 13 adjacent to the at least two side edges 18 and having a top edge 54. Moreover, the roll forming machine 100 forms at least one side panel 60 extending downward from the top edge 54 and inwardly bends and forms the upwardly facing lower channel section 14.

The grow gutter typically is installed proximate the top of greenhouse usually be suspending the grow gutter segments from the ceiling or other support structure of the building typically using steel rods 200 having a hook end 202 that matingly receives the bottom of the upwardly facing lower channel section 14. The nutrition mat may be engaged with the top surface 82 either before or optionally after the grow gutter is mounted proximate the ceiling of the greenhouse structure. Plant seeds or plants to be grown are typically added to the nutrition mat.

In operation water or other liquid applied to the plant, plant seed and/or nutrition mat and excess water or other liquid is drained from the top surface 82 of the upper bridge section 12 into the upper channel section 13. Finally the water or other liquid is received into the lower channel section 14 through a plurality of pass through holes 40 which are disposed on the upper channel section 13.

The roll forming machine 100 is transportable and capable of being brought to any commercial greenhouse site in order to produce the horticultural grow gutter 10 in the same location as it will be used. Having a roll forming machine 100 which produces the grow gutter on site also allows for specific widths 92 and lengths 24 of the horticultural grow gutter 10 in order to optimize horticultural growth for each desired consumer. The depth A, 76 of the upper channel section 13 and the lower channel section 14 can be varied according to plant breed specifications, provided that sufficient profile strength is still evident. Other potential requirements and wishes of a consumer can also be incorporated in the horticultural grow gutter 10 design by means of changing the constructive specifications of the rollers 104 in the roll forming machine 100.

Those skilled in the art will recognize, or be able to ascertain using no more than routine experimentation, many equivalents to the specific embodiments of the invention described herein. Such equivalents are intended to be encompassed by the following claims.

The invention claimed is:

1. A horticultural system comprising a horticultural grow gutter produced from a single sheet of material comprising:
an upper bridge section having an upper nutrition mat receiving top surface, a length, a bottom surface, and two side edges;
two upwardly facing upper channel sections each individually integral with one of the two side edges along at least substantially all of the length of the upper bridge section and having a top edge extending above the upper nutrition mat receiving top surface and a channel bottom having a plurality of aperture positioned in the bottom of the upwardly facing upper channel section configured to allow a liquid to pass through the apertures by gravity;
two side panels each individually integral with one of the top edge and extending downward from the top edge; and
an inwardly bent and upwardly facing lower channel section integral with each side panel wherein the upwardly facing lower channel section is sized and positioned to receive the liquid passing through the apertures disposed below the upper channel section.

2. The horticultural grow gutter of claim 1, wherein each of the upper channels are individually engaged along the entire length of one of the side edges.

3. The horticultural grow gutter of claim 1, wherein the upwardly facing lower channels are individually connected to one side panel and not engaged with any other portion of the gutter.

4. The horticultural grow gutter of claim 1, wherein the upper channel is a generally U-shaped channel.

5. The horticultural grow gutter of claim 4, wherein the lower channel is a generally U-shaped upwardly facing channel.

6. The horticultural grow gutter of claim 1, wherein the each upper channel includes a plurality of the apertures wherein the apertures are capsule-shaped.

7. The horticultural grow gutter of claim 5, wherein the downwardly extending side panel includes an outwardly projecting section extending at an obtuse angle.

8. The horticultural grow gutter of claim 1, wherein the entire bottom surface of the upper bridge section is open and visible when viewed with the naked eye and wherein the upper bridge section is free of recesses, apertures or channels.

9. The horticultural grow gutter of claim 1, wherein the bottom surface is concave downward and the upwardly facing lower channel sections do not connect with one another across the bottom surface of the upper bridge section and a first end of the grow gutter is positioned higher than a second end of the grow gutter such that the liquid in either the upwardly facing upper channel sections and the upwardly facing lower channel sections flows by gravity within the channel sections.

10. A horticultural grow gutter comprising:
an upper bridge section having an upper nutrition mat receiving member thereon, a downwardly concave bottom surface and at least two side edges which extend an entire length of the bridge section;
two generally U-shaped upwardly facing upper channel section integral with at least one of the at least two side edges wherein the upwardly facing upper channel section includes a top edge which extends the entire length of the bridge section;
two downwardly extending side panel which extends from the top edge and forms and inwardly bent, and upwardly facing lower channel section configured to receive water or other liquid from the upper channel section; and
wherein the bottom surface of the upper bridge section is permanently visible throughout the entire length of the bridge section.

11. The horticultural grow gutter of claim 10 wherein the lower channel section is a generally U-shaped channel.

12. The horticultural grow gutter of claim 10 wherein the upper channel includes a plurality of apertures which are configured to allow water or other liquid to drain from the upper channel to the lower channel.

13. The horticultural grow gutter of claim 10, wherein the downwardly extending side panel includes an outwardly projecting section such that the water or other liquid falling from the upper channel to the lower channel is all received into the lower channel.

14. The horticultural grow gutter of claim 10 wherein the lower channel section is configured to receive water or other liquid from the upper channel section.

15. The horticultural grow gutter of claim 10, wherein the at least one upwardly facing lower channel is connected to the at least one side panel and no other portion of the gutter.

16. A method comprising the following steps:
providing a single, non-pre-punched sheet of material; and
using a machine to form the following steps from a horticulture grow gutter in a continuous process from the single non-pre-punched sheet of material where the grow gutter comprises:
an upper bridge section having an upper nutrition mat receiving top surface, a bottom surface, and at least two side edges;
an upwardly facing upper channel section adjacent to each of the at least two side edges and having a top edge and a plurality of pass-through apertures dispensed in a bottom of the upwardly facing upper channel sections;
a side panel extending downward from each top edge and forming an inwardly bent and upwardly facing lower channel section positioned below the upwardly facing upper channel section.

17. The method of claim 16 further comprising the steps of:
installing the horticulture grow gutter substantially adjacent a top of a greenhouse such that a first end of the horticulture grow gutter is higher than a second end of the horticulture grow gutter such that gravity forces water within the channels downward along the channels;
draining water or other liquid from the upper nutrition mat receiving member into the upper channel section; and
receiving the water or other liquid into the lower channel section through a plurality of pass-through apertures disposed in the upper channel section.

18. The method of claim 16, wherein the downwardly extending side panel includes an outwardly projecting section, the bottom surface of the upper bridge section is visible throughout an entire length of the upper bridge section; the upper channel section is a general U-shaped channel; and the lower channel section is a generally U-shaped channel.

19. The method of claim 16 further comprising the steps of:
engaging a plant nutrition mat on at least a portion of the top surface and watering the nutrition mat with water such that excess water travels off the top surface and into the upwardly facing upper channel, through the apertures and into the upwardly facing lower apertures; and
wherein the upper bridge section is concave downward such that water falls by gravity toward the upwardly facing upper channels.

20. The method of claim 16 further comprising the steps of:
growing one or more plants on the top surface such that the plant roots do not grow within the upwardly facing lower channel sections;
cleaning the upwardly facing lower channel sections by accessing an open space section along the entire length of the grow gutter and spraying water along the upwardly facing lower channel sections; and
wherein the upper channel section is a generally U-shaped channel and the lower channel section is a generally U-shaped channel.
